(19) United States
(12) Patent Application Publication
(10) Pub. No.: US 2006/0132919 A1
(43) Pub. Date: Jun. 22, 2006

(54) Composite for beam shaping

(76) Inventors: Rupert Schnell, Worms (DE); Edgar Pawlowski, Stadecken-Elsheim (DE); Wolfram Beier, Essenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/247,984

(22) Filed: Oct. 12, 2005

(30) Foreign Application Priority Data
Oct. 13, 2004 (DE) 102004049954.3
Oct. 22, 2004 (EP) 04105252.3

(51) Int. Cl. G02B 27/44

(52) U.S. Cl. 359/565

(57) ABSTRACT

The present invention relates to beam shaping elements, such as for example lenses, diffractive elements or mirrors, which exist as composites, comprising an inorganic substrate and an organic substrate in the form of a polymer, which can be thermally cured at temperatures between 0 and 180° C. Preferably, the organic polymer is selected from the group consisting of polyurethanes and silicones. According to a preferred embodiment, it is a polyurethane. The beam shaping elements according to the present invention have advantageous properties with respect to precision, rigidity and durability and can further be produced in an easy way by means of an economic method, which method is also subject of the invention.

The present invention relates to beam shaping elements, such as for example lenses, diffractive elements or mirrors, which exist as composites, comprising an inorganic substrate and a component having an organic proportion, which is referred to as organic component, in the form of a polymer. The polymer is formed by a thermally initiated process from two or more starting components in the described production method. The thermal initiation is effected at temperatures between 0 and 180° C. Preferably, the organic polymer is selected from the group consisting of polyurethanes and silicones. According to a preferred embodiment, said polymer is a polyurethane.

The beam shaping elements according to the present invention have advantageous properties with respect to precision, rigidity and durability and can further be produced in an easy way by means of an economic method, which method is also subject of the invention.

From the state of the art different composite materials are known which comprise glass as an inorganic component.

In U.S. Pat. No. 4,690,512 a composite lens is described which either consists of glass combined with plastic or of two plastic parts, wherein the elements are connected with each other by means of an optical putty. The putty connection between the element of the plastic should be improved by a layer of an aliphatic polyurethane. U.S. Pat. No. 5,323,191 describes “glass plastic lenses”, wherein a thin glass layer is bonded to a thicker and transparent organic component. The connection is achieved by an adhesive layer on the basis of polyurethane having particular properties. EP 0 182 503 relates to an optical laminated lens, wherein an optical clear, cohesive and adhesive elastomeric binder connects the part of the lens which preferably consists of photochromic glass with the plastic part of the lens.

It will be appreciated from the state of the art that the use of different materials, in particular of inorganic and organic materials, for the production of beam shaping elements, in particular of lenses, can only be effected by means of complicated adhesive techniques. Therefore there is a need for providing beam shaping elements which comprise on the one hand an inorganic substrate and on the other hand an organic component, wherein the beam shaping element only comprises both said components and does not have an additional layer of a substance, which acts as an adhesive or binder. Such an element should furthermore be producible in an easy and economic way.

Surprisingly it was found that an inorganic substrate, such as for example glass, quartz glass, silicon, metal or a mineral coated with a polymer, such as a polyurethane or a silicone, is superiorly suitable as a beam shaping element and has in this case superior properties, such as high precision, good rigidity and durability. Preferably used polyurethanes are aliphatic polyurethanes; preferably used silicones are addition crosslinking systems. A particularly preferable polyurethane is the “PUR Glasklar System” of the company Ruihl Puromer GmbH or Elastoclear of the company Elastogran. Both materials are featured by the use of aliphatic isocyanates for the iso-component.

The beam shaping element according to the present invention may either be candled, so for example it may have the form of a lens, but it may also be used for reflecting light, for example in the form of a mirror. Insofar for example, the beam shaping element according to the present invention is as a lens designed in a transparent manner, thus all selected materials are transparent.

Furthermore, the present invention relates to a cheap and easy method for producing a beam shaping element having superior properties.

For the production of the beam shaping element according to the present invention for example, a glass plate is placed and fixed in a mold. For a polyurethane coating, the diol and isocyanate components of the polyurethane are metered in a suitable apparatus, mixed and given into the mold. An exemplary suitable apparatus is a high pressure metering device for polyurethane processing. The evacuation of all components prior to their use is advantageous. In this way, trapped gases or trapped highly volatile contaminants are removed and correspondingly the formation of bubbles in the product can be reduced respectively eliminated. For the production of polyurethane during charging the mold, preferably all components are under a pressure of 0 to 100.000 hPa, more preferably under a pressure of 1.000 to 50.000 hPa. So the surface and structure quality can be improved and a formation of bubbles can be eliminated.

For the production of a composite with silicone as organic component due to the longer pot life the mixture of the components has not to be directly effected with a mixing head near the mold tool.

For achieving a specific beam shaping, during the production method a structuring of the surface has to be incorporated. Preferably, this is effected by a structured area of the mold which will be in contact with the organic component, such as the polyurethane. The structured area may consist of metal, glass, quartz glass, silicon or polymers. Particularly suitable are materials such as silicone, for example RTF silicones, or polymers containing fluorine having low surface energy, so that release agents can be completely or partially avoided.

For an acceleration of the chemical reaction, preferably the components and the mold can be heated, for example to temperatures in a range of about 0° C. to 18° C., preferably 0 to 150° C. and more preferably 0 to 100° C. A temperature range which for example is suitable for the use of polyurethanes is 4° C. to 100° C., according to a particularly preferable embodiment it is 80° C. Depending on the-organic component, the person skilled in the art will select a suitable temperature. The use of UV light for curing the organic phase is not necessary and also not desired which is an advantage of the present invention in relation to the state of the art, because so the technological effort can be reduced. If a curing step by means of UV light can be avoided, further there is the advantage that also non-transparent materials can be used.

The method according to the present invention allows freely selecting the thickness of both components which allows the production of beam shaping elements having any shape.

Compared with pure organic optical elements, due to the use of an inorganic substrate, such as glasses, semiconductors or crystals, such as for example quartz or CaF₂, the optical element has a lower thermal expansion, a higher rigidity and temperature resistance. This allows the use also at varying temperatures and environment influences.

Suitable glasses are for example silica glasses (quartz glasses), here various types may be employed which have a high difference in the content of OH, halogens or cations; doped quartz glasses, e.g. with respect to zero expansion with TiO₂ such as the ULE glass (ultra low expansion) of the company Corning, with respect to a specific change of the refraction index also with GeO₂ or fluorine etc.; soda-lime silicate glasses; alkaline-earth aluminosilicate glasses (alkali free and alkali oxide containing); borosilicate glasses; phosphate glasses; fluorophosphate glasses; borophosphate glasses; borophosphosilicate glasses; solder glasses and glasses having low Tg; optical glasses, as well as lead containing (such as e.g. SF6 from Schott) and also lead free (such as e.g. BK7 from Schott); color and filter glasses, ion colored; color and filter glasses, colored through the deposition of a second nanophase (temper glasses with a second colloid phase of metals or semiconductors); laser glasses; glasses containing rare-earths and other “active” glasses on the basis of silicate or on other basis (e.g. glasses containing a great amount of antimony oxide); Faraday glasses; fluoride glasses and other halogenide glasses; chalcogenide glasses, e.g. such one of systems like Se—As—Ge; sulphide glasses, telluride glasses etc.

Suitable glass ceramics are for example:

Lithium aluminosilicate systems (LAS); magnesium aluminosilicate systems (MAS); glass ceramics which can be processed with machines such as MACOR of the company Coming; sintered glass ceramics, in particular optical transparent nanoglass ceramics which are produced by sintering ways; glass ceramics which are produced by organic or inorganic sol-gel processes, in particular optical transparent nanoglass ceramics which are produced in this way.

Optionally it is possible to increase the optical functionality by an addition of suitable substances. Thus for example, for UV protection UV absorbing agents may be added to both components. Nanoparticles, such as for example TiO₂, Al₂O₃, Fe₂O₃, CeO₂, ZnO, ZrO₂, SiO₂, In₂O₃, SnO₂, NiO, Fe, Al, Au, Ag, Ni, may be added for increasing the refraction index, varying the dispersion or achieving other properties. Optionally, for achieving a scattering effect (as a so-called diffuser) also particles may be added which preferably have a particle size of greater than 10 nm and have a refraction index which is different to that of the organic component. Here in particular particles are suitable which have a refraction index which is different to that of polyurethane. Such particles may for example be glass powder or polymers.

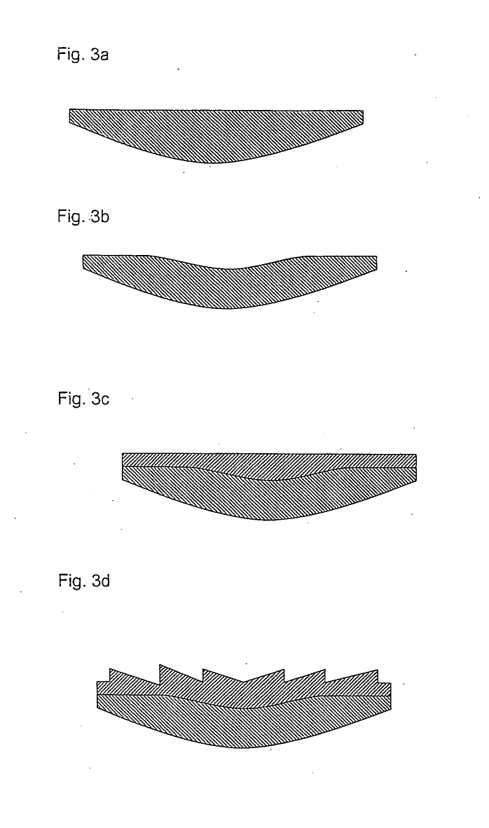

The method according to the present invention can be used for the correction of shape deviations at hot embossed glass components, such as for example lenses, in particular components having high differences in thickness, such as for example DE lenses (threefold ellipsoid, in German: ‘dreifach ellipsoid’) for automobile front head-lights. FIG. 3a shows a hot embossed component, at first in the target shape. This shape may undesirably change after the hot embossing process (FIG. 3b) which by means of the setting according to the present invention may be again compensated by the deposition of the polymer (FIG. 3c). Then, FIG. 3d shows an embodiment of the invention according which by means of the polymer not only the compensation of the “defect” can be achieved, but the organic polymer imparts a structured surface to the lens.

Typical shape deviations of the glass body in this process are in particular sunk spots which appear during the cooling process during the hot embossing of DE lenses by the shrinkage of the glass. The use of the polymer for correction purposes is particularly advantageous, when through the selection of the material the difference of refraction index and dispersion of glass and polymer is kept low. So besides systematic process imperfections also variations during the production method can be compensated which allows designing the process more cheaply.

The optical elements according to the present invention may also be used in a combination and/or they may have a multi-layer structure. So the composite may consist of several layers of organic and inorganic material each. Multi-layer composites may also contain different inorganic materials, such as different glasses.

Further, the optical elements according to the present invention may be used for the aspherical over-shaping of spherical lenses which improves their optical properties. Through the method according to the present invention it is also possible to generate a diffractive structure on a flat substrate or on a lens. It is also possible to attach holders, adjusting devices or the like at a lens or to deposit refractive or diffractive optical elements on semiconductors, such as for example LEDs, CMOSs, CCDs, VCSEL (vertical cavity surface emitting laser) etc.

Through a suitable design of the diffractive optical element (DOE) the effect of an optical “low pass filter” on an element of a digital picture input unit (CCD, CMOS) may be achieved.

Also optical structures for influencing the reflection, such as for example for an element having an antireflection coating, may be incorporated into the composite. This also belongs to optical substrates, such as filter glasses, polarizers etc.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

With the following embodiment examples the present invention should be described in more detail without limiting it by that:

### EXAMPLE 1

A glass lens is placed in a mold tool having a parting plane. For taking up the lens, in the tool a fit of a silicone elastomer is present. Suitable materials for the fit are gum and rubber, silicones, fluoropolymers or corresponding materials having a lower hardness than glass. The tool is a constituent of a high pressure casting facility for polyurethane. The concept of the facility corresponds to the system which was developed by Krauss Maffei Kunststofftechnik, Munich for the so-called clear coat molding. Advantageous for the little amounts of materials which are typically used for optical hybrids is the circulation of the components in a corresponding ring-pipe system. For processing the components, the complete storage and transport system is heated to 50 to 80° C. For maintaining the purity of the components and for eliminating trapped air, the buffer tanks and charging tanks are evacuated.

The PU components with the product name Elastoclear were bought from the company Elastogran, Lemforde.

The mixing head is directly attached at the mold tool. In this way a contamination through a mixing head port is prevented. With the help of a pressure gauge inside the mold tool the metering was stopped after achieving an internal tool pressure of 15 bar (15.000 hPa). The internal pressure has shown to be particularly advantageous, because compared with lower pressures so the formation of bubbles could be reduced and the quality of the surface could be improved.

The polymerisation of the components happened at a tool temperature of 80° C. within 3 minutes. Subsequently the tool was opened and the hybrid was removed.

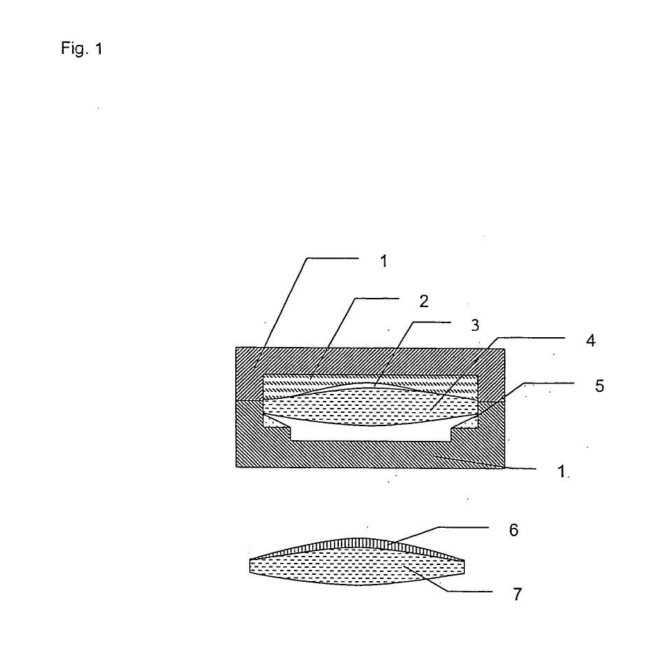

FIG. 1 shows a composite according to the present invention in the form of a lens, inside the tool mold as well as also outside of it.

### EXAMPLE 2

A glass plate is placed in a mold tool having a parting plane. Both halves of the tool contain a structured area which consists of silicone elastomer. The surface structure of one half forms a diffractive optical element (DOE) and the structure of the second half forms a Fresnel lens.

On both sides a cavity remains between the glass plate and the structured surfaces of the tool. This is filled up with PU (polyurethane), such as described in example 1.

After opening the tool, the hybrid can be removed. In the core it contains a glass plate and at the surfaces polyurethane. The hybrid carries on one surface a DOE and on the other surface a Fresnel lens.

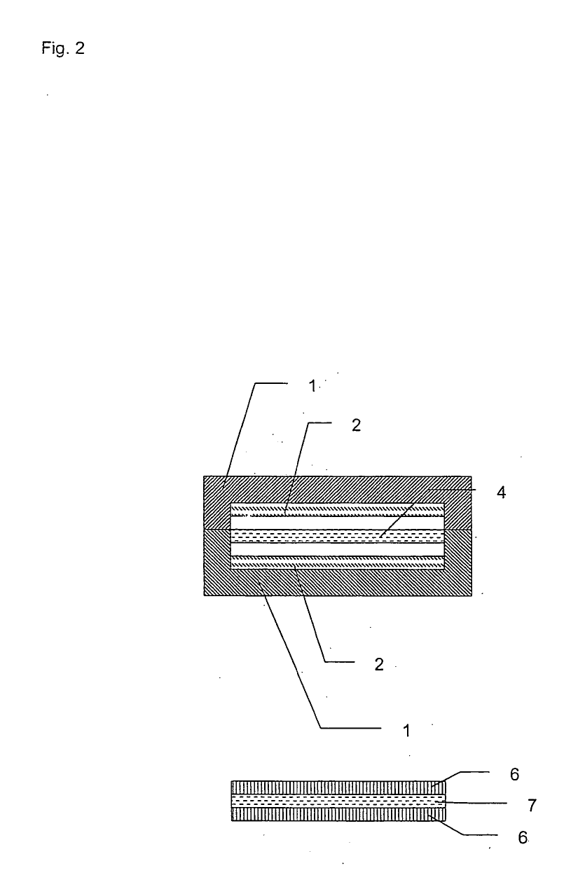

FIG. 2 shows a composite according to the present invention in the form of a plate, inside the tool mold as well as also outside of it.

Optionally, such a composite may be manufactured in such a way that a polymer layer or several polymer layers are sandwiched by two glass layers.

Examples can be seen in the FIGS. 3 to 13.

FIG. 3a shows a hot embossed component, at first in the target shape;

FIG. 3b shows a hot embossed component having an undesired changed shape after the hot embossing process;

FIG. 3c shows the setting according to the present invention through the deposition of the polymer;

FIG. 3d is an embodiment of the invention,

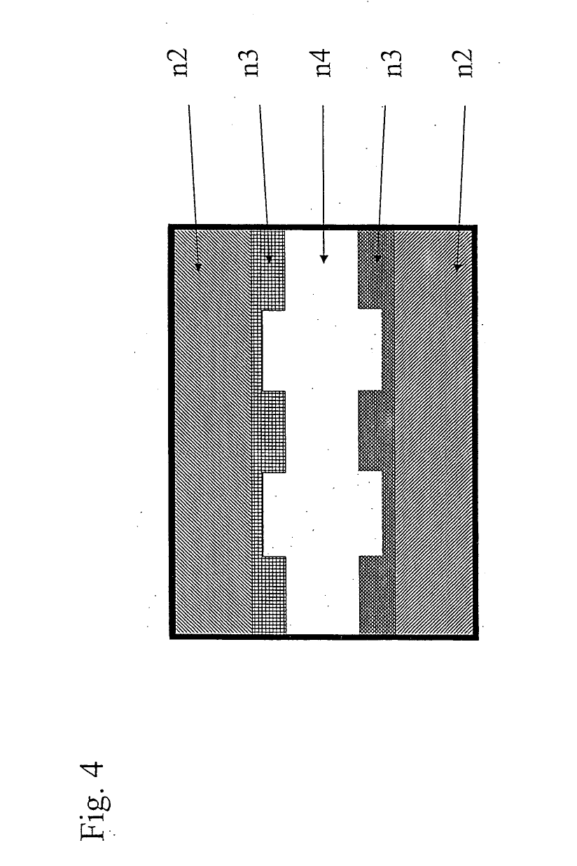

FIG. 4 shows a beam shaping element having two diffractive optical elements, build as a grating in a layered waveguide. Both substrates are connected by a polymer (pol)yurethane);

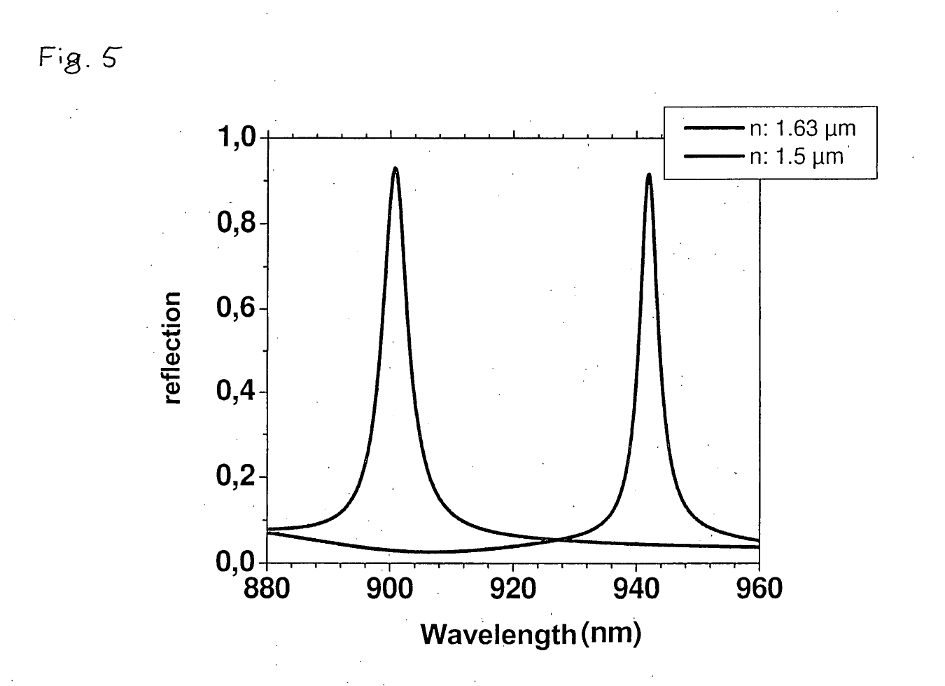

FIG. 5 shows a calculated reflection spectrum for a layered waveguide grating structure for two different refraction indices (n: 1.63 and n: 1.5);

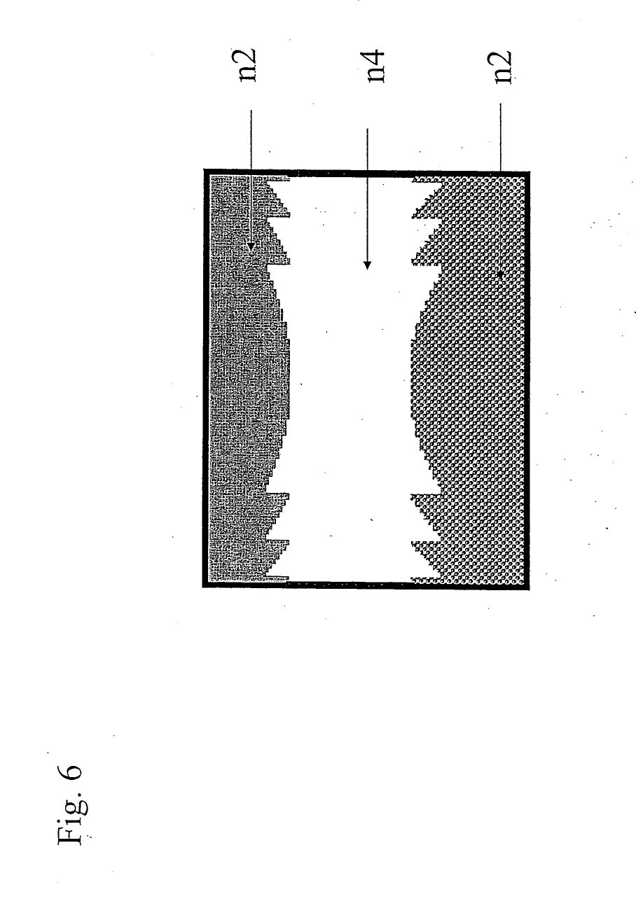

FIG. 6 shows a beam shaping element having two stepped diffractive optical elements (n2 and n4), connected by a polymer (PU) and structured in an inorganic substrate (glass). The diffractive optical elements fulfil the function of an aspherical lens;

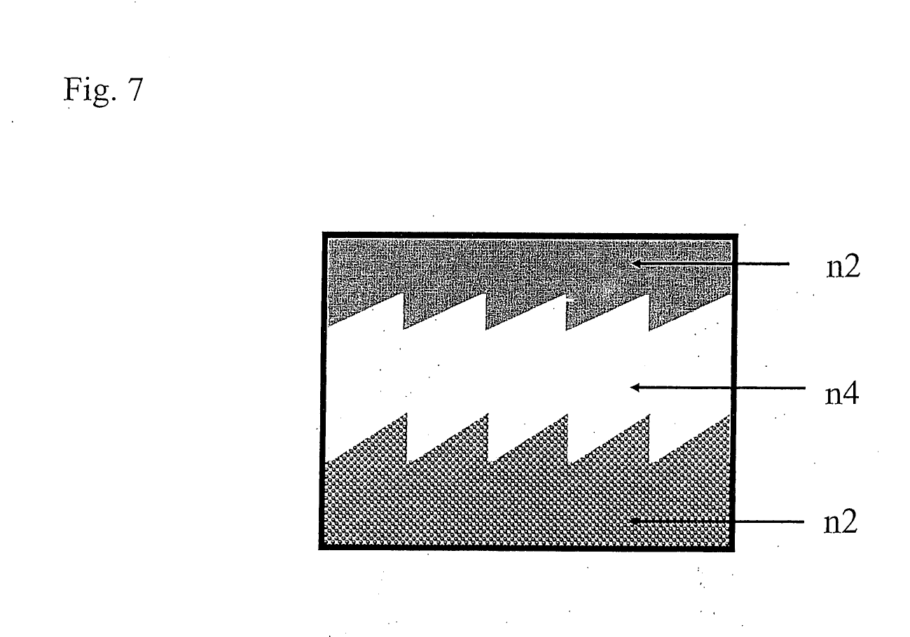

FIG. 7 shows a beam shaping element having two blazed diffractive optical elements (n2 and n4), connected by a polymer (polyurethane) and structured in an inorganic substrate (glass);

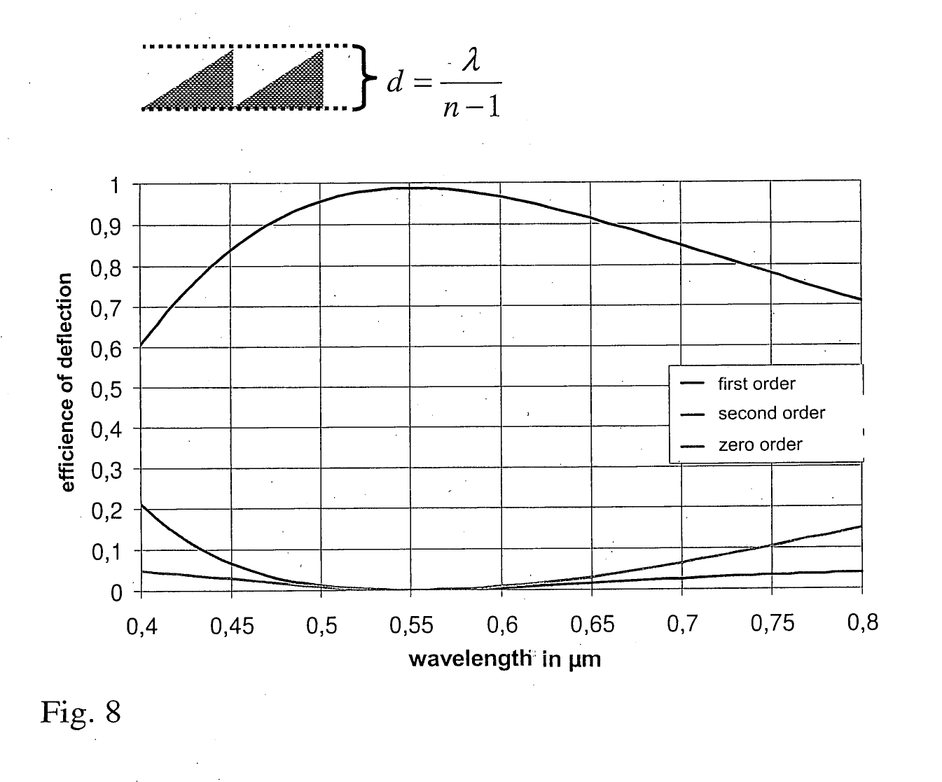

FIG. 8 shows a calculated diffraction efficiency of a usual blazed grating for the 0th, 1st and 2nd order in dependence on the wavelength. The structural height d is d=λ⁻/n−1, wherein n is the refraction index of the grating material;

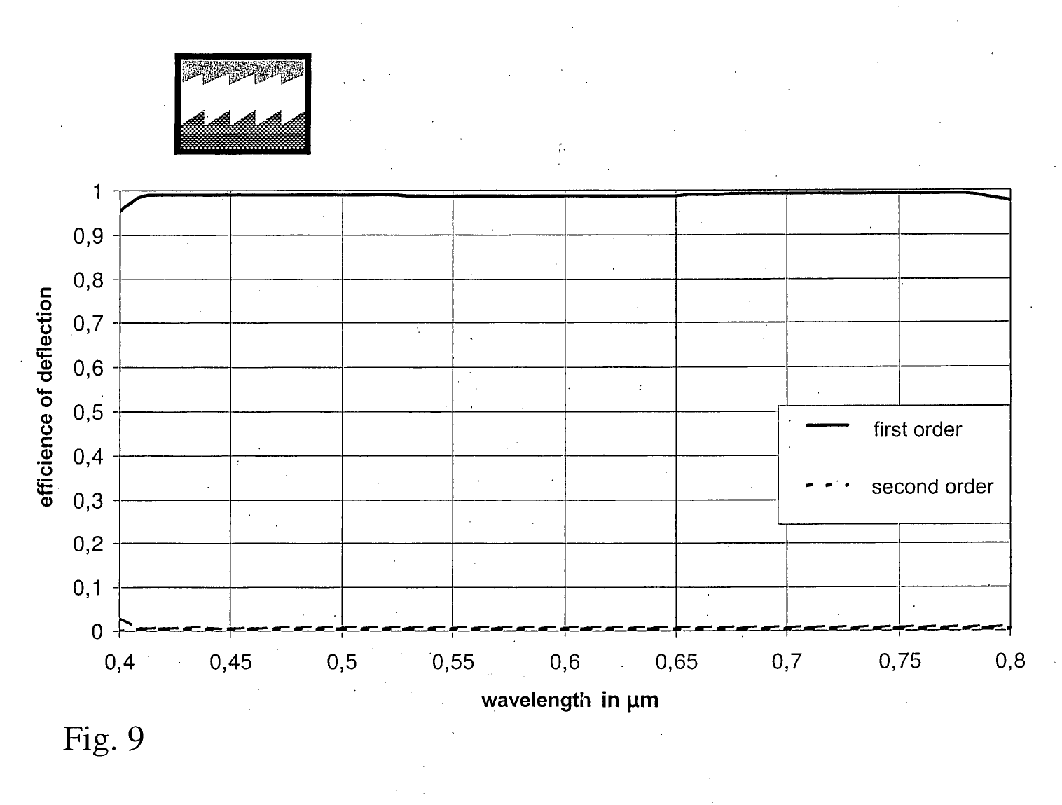

FIG. 9 shows a calculated diffraction efficiency of a combination of two blazed gratings of different materials, such as shown in FIG. 4 or FIG. 6. The diffraction efficiency is shown for the 0th, 1st and 2nd order in dependence on the wavelength;

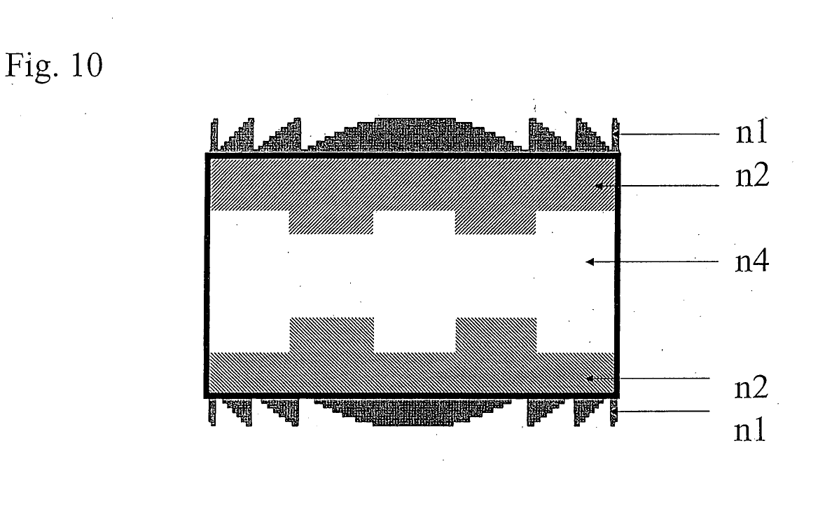

FIG. 10 shows a beam shaping element-having two stepped diffractive optical elements (n1), each at a substrate having diffractive optical elements (n2) which are connected by a polymer (n4 e.g. PU);

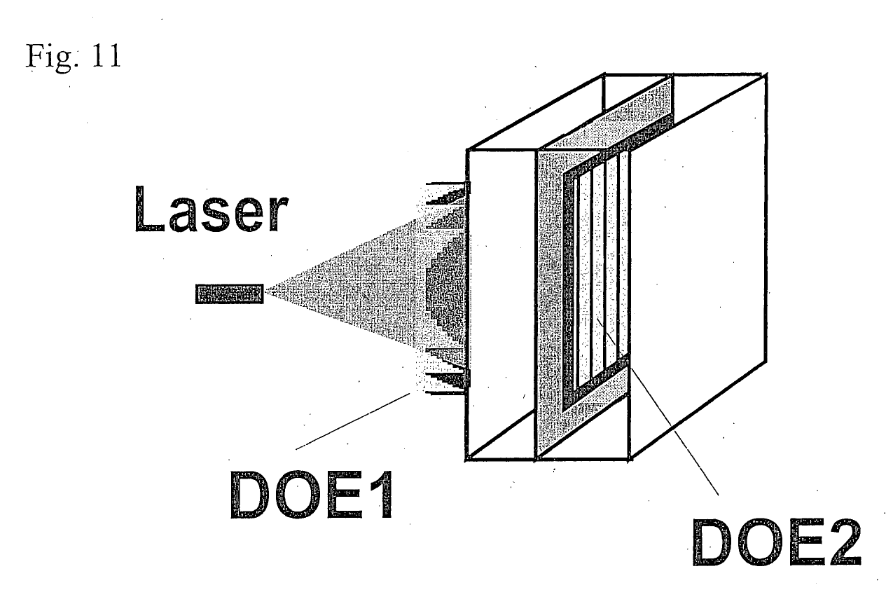

FIG. 11 shows a beam shaping element consisting of two diffractive optical elements (DOE1 and DOE2) which serves to collimate (DOE1) and frequency-selectively reflect or narrow (DOE2) divergent laser light;

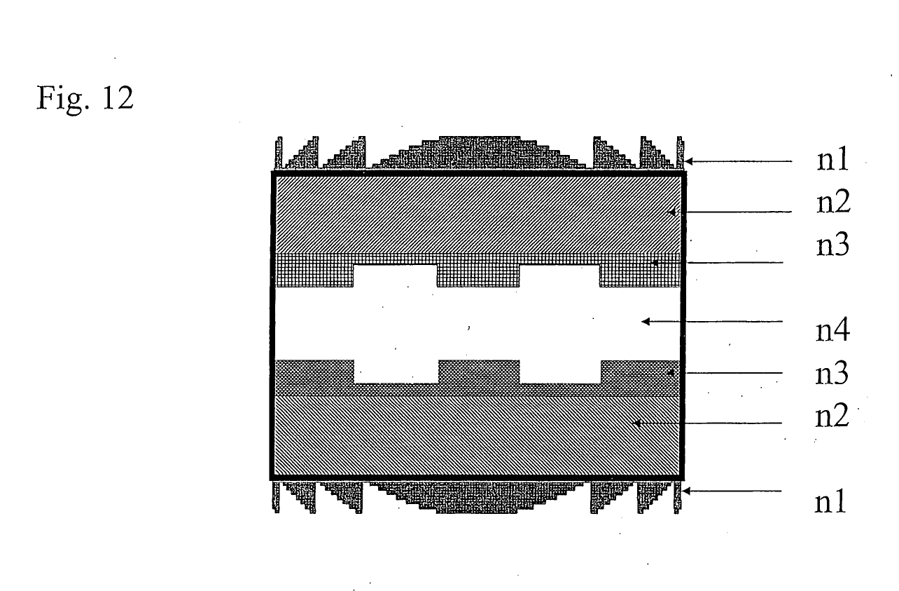

FIG. 12 shows a beam shaping element having two stepped diffractive optical elements (n1) on one substrate (n2) each which back side is covered with diffractive optical elements in the form of waveguide gratings (n3) which are connected by a polymer (n4);

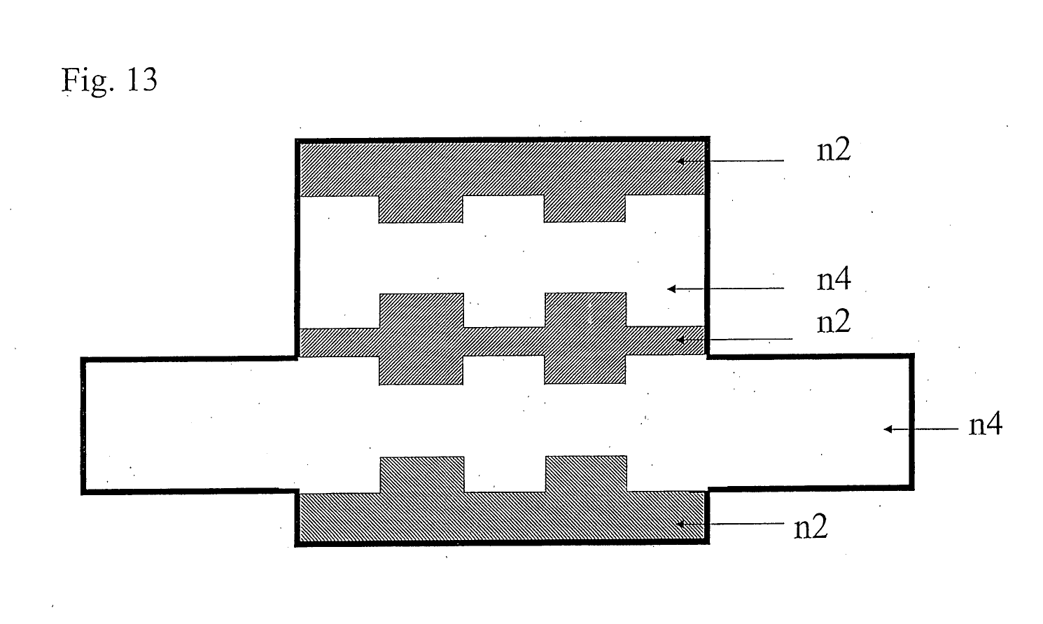

FIG. 13 shows a beam shaping element having different diffractive optical elements on an inorganic substrate n2 which are connected by a polymer (n4 is the polymer layer). n4 may have the function of a “mounting element” or a part of a casing or the like for the beam shaping element.

### LIST OF REFERENCE CHARACTERS

1 Tool mold half
2 Structured area
3 Cavity
4 Glass lens
5 Fit
6 Polymer
7 Glass
(a) Target shape of the lens
(b) Shape of the lens after the hot embossing process
(c) Setting according to the present invention with compensation of the shape deviation through the polymer
(d) Setting according to the present invention with compensation of the shape deviation and an additional optical function through a structured surface
n1 Glass or layer e.g. SiO₂
n2 Glass
n3 Layer e.g. TiO₂
n4 Polymer, e.g. PU

The entire disclosures of all applications, patents and publications, cited herein and of corresponding German application No. 102004049954.3, filed Oct. 13, 2004 and European application No. 04105252.3, filed Oct. 22, 2004, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A beam shaping element existing as a composite, comprising at least an inorganic substrate, selected from the group consisting of glass, semiconductor materials, metals, ceramics or crystals, and at least one component having an organic proportion, in the form of a polymer, wherein the polymer is formed of two or more starting components by thermal initiation at temperatures between 0 and 180° C. and wherein the respective layers of organic substrate and inorganic component are directly connected with each other during the formation of the organic substrate.

2. The beam shaping element according to claim 1, selected from the group consisting of lenses, diffractive elements, mirrors or optical systems.

3. The beam shaping element according to claim 2, wherein the diffractive element is selected from linear gratings, chirped gratings, sawtooth gratings, Fresnel lenses, CGHs (computer generated holograms).

4. The beam shaping element according to claim 1, wherein the inorganic substrate is selected from the group consisting of silica glasses, doped quartz glasses, soda-lime silicate glasses, alkali free or alkali oxide containing alkaline-earth aluminosilicate glasses, borosilicate glasses, phosphate glasses, fluorophosphate glasses, borophosphate glasses, borophosphosilicate glasses, solder glasses and glasses having low Tg, lead containing or lead free optical glasses, optionally ion or colloid colored color and filter glasses or glass ceramics.

5. The beam shaping element according to claim 1, wherein the inorganic substrate is an asphere.

6. The beam shaping element according to claim 5, wherein the asphere is a threefold ellipsoid (DE) lens.

7. The beam shaping element according to claim 1, wherein the beam shaping element is a semiconductor.

8. The beam shaping element according to claim 7, wherein the semiconductor component is a CCD or CMOS sensor or LED or VCSEL.

9. The beam shaping element according to claim 1, wherein the beam shaping element is a low pass filter.

10. The beam shaping element according to claim 1, wherein the polymer is selected from polyurethanes or silicones.

11. The beam shaping element according to claim 1, wherein the polymer is selected from the group consisting of polyurethanes having an aliphatic isocyanate (HDI) component or addition crosslinked silicones.

12. The beam shaping element according to claim 1, which comprises at least three materials in the form of three layers.

13. The beam shaping element according to claim 12, wherein the refraction indices and/or the Abbe numbers of at least three materials, which comprise an inorganic substrate and components having an organic proportion, are different.

14. The beam shaping element according to claim 1, wherein the different materials, which comprise an inorganic substrate and components having an organic proportion, exist in the form of different layers M1, M2, M3.

15. The beam shaping element according to claim 1, wherein the layers M1, M2 and M3 are adjacent to each other.

16. The beam shaping element according to claim 1, wherein the corresponding Abbe numbers v1, v2, v3 of the layers M1, M2 und M3 are defined as follows:
v1<v2<v3 or
v1>v2<v3 or
v1>v2>v3.

17. The beam shaping element according to claim 13, wherein the refraction indices satisfy the following equation
±(n₁−1)d₁±(n₃−1)d₂±(n₂−1)d₂=mλ0, wherein
n₁=refraction index of material 1 (M1)
n₂=refraction index of material 2 (M2)
n₃=refraction index of material 3 (M3)
d₁=structural height of material 1 (M1)
d₂=structural height of material 2 (M2)
d₃=structural height of material 3 (M3).

18. The beam shaping element according to claim 1, wherein at least one material, which comprises an inorganic substrate and a component having an organic proportion, has a refraction index n_{D} of higher than 1.75.

19. The beam shaping element according to claim 1, wherein the exteriorly arranged surfaces of the materials of the respective inorganic substrate and/or the component having an organic proportion have an optically effective structure.

20. The beam shaping element according to claim 1, wherein at least one of the materials, comprising an inorganic substrate and a component having an organic proportion, besides the optical function has also a mechanic function and is accordingly shaped.

21. The beam shaping element according to claim 20, wherein the mechanic function is suitable for fixing, assembling, clamping, adjusting or installing.

22. A method of producing a beam shaping element, comprising the steps of
placing an inorganic substrate in a mold
fixing the inorganic substrate
charging the starting components of the polymer onto the inorganic substrate by casting into the mold and
thermally initiated chemical reaction of the starting components of the polymer at a temperature in the range of 0 to 180° C.

23. The method according to claim 22, wherein the charging pressure of the mold is 0 to 100.000 hPa, preferably 0 to 50.000 hPa.

24. The method according to claim 22, wherein mold release agents can be avoided through a suitable selection of the materials of the mold.

25. The method according to claim 22, wherein prior the chemical reaction the starting components of the polymer are degassed at reduced pressure.

26. The method according to claim 22, wherein as a polymer polymeric polyurethane components are processed in a high pressure mixer and wherein optionally ring-pipe systems with circulation are used.

27. The method according to claim 26, wherein for processing the polyurethane components-are heated to temperatures of 20 to 100° C.

28. The method according to claim 27, wherein for processing the polyurethane components are heated to temperatures of 30 to 80° C.

29. The method according to claim 22, wherein the charging process of the mold is controlled by time, by volume, by the pressure of the components, by the internal pressure of the mold in the gate area or by the internal pressure of the mold in the overflow area.

30. The method according to claim 22, wherein a beam shaping property during the production process is achieved by structuring the surface of the component having an organic proportion.

31. The method according to claim 30, wherein in the mold the structure which is achieved by the structuring is a negative.

32. The method according to claim 22, wherein the element of the mold carrying the structure consists of a material having low surface energy.

33. The method according to claim 22, wherein the material of the mold having low surface energy is selected from silicone or polymers containing halogens.

34. The method according to claim 33, wherein the polymer containing halogens is selected from PTFE or PVDF.
